(19) United States
(12) Patent Application Publication
(10) Pub. No.: US 2022/0088549 A1
(43) Pub. Date: Mar. 24, 2022

(54) PHARMACEUTICAL COMPOUNDING DEVICE FOR INTRAVENOUS CHEMOTHERAPY

(71) Applicant: KIRO GRIFOLS, S.L., ARRASATE (GIPUZKOA) (ES)

(72) Inventors: NAIARA TELLERIA GARAY, ARRASATE (GIPUZKOA) (ES); BORJA LIZARI ILLARRAMENDI, ARRASATE (GIPUZKOA) (ES); RAMON ALONSO SOTO, ARRASATE (GIPUZKOA) (SE)

(21) Appl. No.: 17/305,928

(22) Filed: Jul. 16, 2021

(30) Foreign Application Priority Data
Sep. 22, 2020 (CN) 2020220904512

(51) Int. Cl. B01F 13/10; B01F 15/00; B01F 13/04

(52) U.S. Cl. CPC B01F 13/1069; B01F 2215/0032; B01F 13/045; B01F 15/00194

(57) ABSTRACT

A pharmaceutical compounding device is for preparing intravenous medicaments used in chemotherapy. The device includes a compounding area with a robotic compounder, a sash window for closing the compounding area during operation of the device, and a sash window sensor system for detecting the open/closed status of the sash window. A pre and/or post-processor is arranged in the device and/or in a separate station. A controller has a security circuit for preventing opening of the sash window when the robotic compounder is performing a compounding operation and the sash window is closed. The controller has a first control circuit for the compounding area and a second control circuit for the pre- and/or post-processor area. The control circuits can be used independently to perform operations in parallel. The security circuit only acts on the first control circuit.

### CROSS-REFERENCE TO RELATED APPLICATION

This application claims priority to Chinese Utility Model Application No. 2020220904512 filed on Sep. 22, 2020, the disclosure of which including the specification, the drawings, and the claims is hereby incorporated by reference in its entirety.

### FIELD OF THE INVENTION

The present invention relates to machines for the automatic preparation of intravenous medication.

In particular, the present invention relates to a pharmaceutical compounding device for intravenous chemotherapy.

### BACKGROUND OF THE INVENTION

Machines for the automatic preparation of intravenous medication are known from the prior art. Many of said machines are used to prepare medications of different base products in very specific amounts and also pack said prepared medications into medical containers suitable for its final use.

Machines known from the prior art, such as the machine disclosed in document EP 2535034 A1, comprise different working areas that are separated from each other; wherein these working areas can comprise a starting product area where the base products are disposed from which the required medication is generated, a transfer tool area where at least one syringe to prepare the medication is disposed, a prepared product area to house the prepared medication, at least one robot to communicate said areas with each other, and a user interface area. This machine comprises a controller with only a single control circuit that commands the entire machine. This controller prevents the use of any device within the machine accessible to the operator whereas it is in automatic compounding mode. Therefore, the machine operator has to wait until the machine completes all steps of the automatic compounding to later carry out tasks that could have been made meanwhile the automatic compounding of the medication was carried out. The lack of a second control circuit means that the automatic compounding and the operator labour cannot be simultaneous and therefore it reduces the productivity of the overall process of the intravenous medication preparation with unnecessary operator waiting times.

Said machines are used to carry out the automatic compounding to protect the operator from repetitive stress injuries and from exposure to hazardous drugs. The compounding area is only opened for loading and unloading; but it is closed during the entire compounding and cleaning processes. Further, said machines provide a continuous ISO 5 class environment during materials loading and automatic compounding of sterile preparations, protecting the user and the environment. Another advantage of said machines is that partially used vials are held in the compounding area for subsequent doses, thereby making optimum use of drugs; and these are fully tracked by the built-in software.

### SUMMARY OF THE INVENTION

It is an object of the present invention to provide a machine for the automatic preparation of intravenous medication that allows carrying out device dependent operations such as loading, automatic compounding and unloading; and device independent operations such as pre-processing and post-processing of the preparations at the same time.

To achieve this goal, the controller of the present invention comprises a first control circuit equipped with a security circuit for a compounding area and a second control circuit for a pre-processing and/or post-processing area, wherein the control circuits can operate independently from each other performing operations in parallel and the security circuit exclusively acts on the first control circuit in command of the compounding area.

The security circuit prevents the opening of a sash window, which closes and isolates the compounding area from an operator area, when a robotic compounder is performing a compounding operation. Similarly, it prevents unauthorised robotic compounding operations when the sash window is open. Further, the security circuit can comprise one or more emergency stop switches operable by the operator.

The introduction of a second control circuit in said controller allows operating and controlling the devices installed in a pre-processing and/or post-processing area independently from the status (i.e. active or inactive) of the compounding area, wherein said devices comprise one or more user interface screens, weighing devices, code scanners and label printers.

Although some phases of the preparation of the medication can be carried out in parallel to the automatic compounding, full traceability of the compounding materials, drug vials, and final preparations is guaranteed throughout the different phases of the preparation by means of bar code and/or datamatrix scanning, vision recognition and printing pre-labels for the final preparations.

Thus, the present invention discloses a machine for the automatic preparation of medication equipped with a structure that improves the productivity and efficiency of said machines by allowing parallel automatic and user controlled operations and therefore reducing time of the overall process.

The pharmaceutical compounding device for preparing intravenous medicaments used in chemotherapy according to the present invention comprises a compounding area with a robotic compounder, a sash window for closing the compounding area during operation of the device, and a sash window sensor system for detecting the open/closed status of the sash window, a pre-processor and/or post-processor arranged in said pharmaceutical compounding device and/or in an external station including a user interface screen and at least one device of the group comprising a weighing device, a code scanner, a label printer or a combination thereof and a controller with a security circuit for preventing opening of the sash window when the robotic compounder is performing a compounding operation and the sash window is closed; wherein the controller comprises a first control circuit for the compounding area and a second control circuit for the pre-processing and/or post-processing area, wherein the control circuits can be used independently from each other performing operations in parallel and the security circuit only acts on the first control circuit.

### BRIEF DESCRIPTION OF THE DRAWINGS

These and other advantages and characteristics of the present invention will be made evident in the light of the drawings and the detailed description thereof.

FIG. 1 shows a front view of an embodiment of a pharmacy compounding device (PCD) in which the controller of the present invention is mounted.

FIG. 2 shows a diagram of the two independent control circuits of a pharmacy compounding device (PCD) according to the present invention.

FIG. 3 shows for explanatory purposes an exemplary process that can be performed on a pharmacy compounding device when the controller of the present invention is mounted thereof.

### DETAILED DESCRIPTION OF THE PREFERRED EMBODIMENTS

Unless defined otherwise, all technical and scientific terms used herein have the same meaning as commonly understood by one of ordinary skill in the art pertinent to devices described. As used herein, the following terms and phrases have the meanings ascribed to them unless specified otherwise.

The term “compounding area” refers to the space inside the pharmacy compounding device that remains isolated from the environment during the automatic compounding process. The term “sash window” refers to the element that closes the compounding area from the environment. In a preferred embodiment, this element allows to see through and opens and closes said area by following a vertical motion, therefore the specific name, but any other means suitable for physically separating the compounding area from the environment could be used, i.e. a rotary door, a rotary window. The term “pre-processing and/or post-processing area” refers to an external area of/to the machine suitable for an operator to weight products, read labels of said products and/or print labels for said products. The pre-processing and/or post-processing area can be in the external part of the device, for example including a scale and/or a code scanner and/or a touchscreen, or it can be placed externally, for example in an external unit or station (for example another separated cabinet or a table) where required peripherals and/or the controller are arranged and/or duplicated.

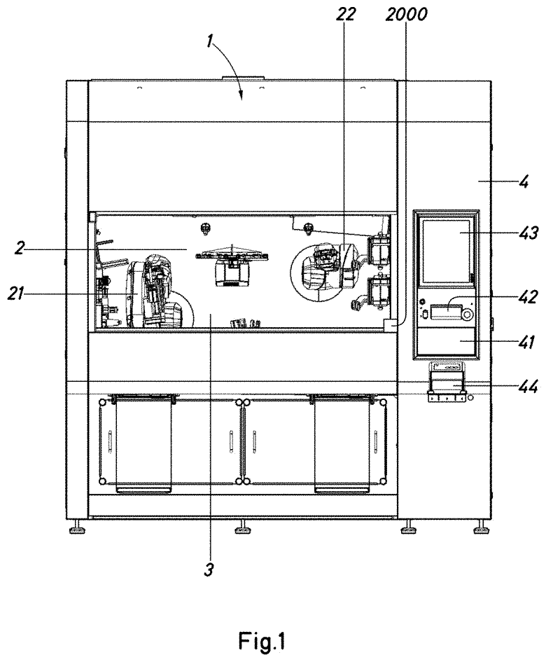

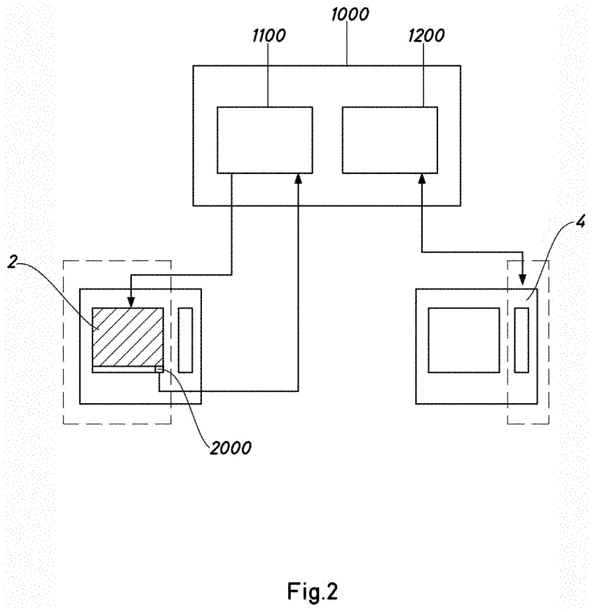

FIG. 1 shows a front view of an embodiment of a pharmacy compounding device (PCD) 1 for the preparation of medication. Said PCD comprises a casing and a sash window 3 to isolate the sterile compounding area 2 from the outside operator area. In this embodiment, the compounding area 2 comprises a robotic compounder comprising two robotic arms 21, 22 to transport and/or handle containers and transfer tools and to carry out a medication preparation in the compounding area. Other different sub-areas, i.e. a starting products sub-area, a transfer tools sub-area and a prepared products sub-area, are located within the same space as the robotic arms 21, 22, so the robotic arms are capable to communicate said sub-areas. A window sensor 2000 is integrated on a security circuit to prevent the operation of the devices in charge of the automatic compounding if the sash window 3 is open. Similarly, an associated control circuit will not allow opening the sash window 3 while the automatic compounding is being performed. Note that the security circuit exclusively acts on the control circuit 1100 (see FIG. 2) in command of the PCD in automatic mode.

The embodiment shown in FIG. 1 depicts the PCD 1 comprising a pre-processing and/or post-processing area 4 arranged in an external area of said machine, wherein a user interface screen 43 can be installed to allow an operator to operate the PCD, so that the robot 21 or the robots 21, 22 act in the manner required to obtain said medication. However, other arrangements of the pre-processing and/or post-processing area are also possible, such as the arrangement of said area within an external station (i.e. a separate airflow cabinet or table where the required devices are duplicated). Further, said area can comprise one or more external weighting devices 41 to verify the weight of the base products before loading them manually into the starting products area and the weight of the medication prepared after unloading. Besides, said area can also comprise a label printer 42 and a code scanner 44, to print and scan the corresponding labels and assure traceability of all products during the medication preparation. A second control circuit 1200 (see FIG. 2) is mounted in said PCD to operate peripheral devices (i.e. interface screens, weighing devices, code scanners and label printers) within the pre-processing and/or post-processing area 4 without interfering with the automatic compounding system.

The functioning of the second control circuit 1200 is not inhibited by the sash window sensor 2000 signal and the corresponding security circuit. Therefore, it is possible to use said peripheral devices when the PCD is being repaired or under maintenance.

FIG. 2 shows schematically the two independent control circuits 1100, 1200 comprised by a controller 1000. Said independent control circuits are in control of a different set of devices of the PCD. The control circuit 1100 operates the automatic systems inside the PCD compounding area wherein the sash window sensor 2000 and emergency switch stops act as safety measures. Additionally, the control circuit 1200 operates the peripheral devices (i.e. devices within the pre-processing and/or post-processing area 4).

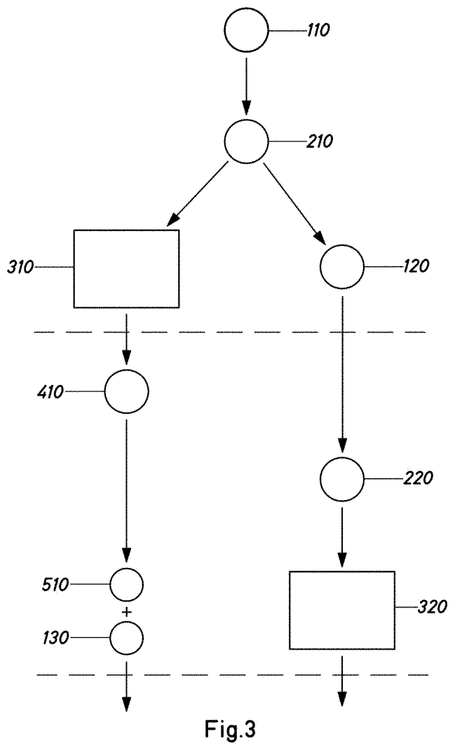

FIG. 3 shows an exemplary process that can be carried out thanks to the addition of the secondary control circuit 1200. Each phase of the process has been identified either by a circle (for phases carried out manually by an operator with the aid of the PCD) or by a rectangle (for phases carried out automatically by the PCD). Whereas the use of a single control circuit impedes to carry out parallel tasks, the use of two independent control circuits allows a more versatile management of the tasks to be done and increase of productivity of the system.

More specifically, FIG. 3 shows that initially an operator can carry out the pre-processing 110 and loading 210 of the products of a first medication. Then, once the sash window is closed the operator can launch the automatic compounding 310 of the PCD and meanwhile this is taking place, the operator is able to carry out the pre-processing 120 of the corresponding products for the preparation of a second medication. Once the PCD finishes the automatic compounding 310, the operator can open the sash window and unload 410 the prepared medication, load 220 the products for the second preparation, close the sash window and launch the automatic compounding 320 of the PCD for the second medication.

Now, while this is taking place, the operator can carry out the post-processing 510 of the first medication and the pre-processing 130 of the corresponding products for the third medication. The processes corresponding to the same medication have been illustrated within the same column in the diagram to easily verify that one complete medication preparation can be overlapped with processes corresponding to the preparation of other medications; this being achieved by using the two independent control circuits within the controller of the present invention.

Although the invention has been set out and described with reference to embodiments thereof, it should be understood that these do not limit the invention, and that it is possible to alter many structural or other details that may prove obvious to persons skilled in the art after interpreting the subject matter disclosed in the present description, claims and drawings. In particular, in principle and unless otherwise explicitly stated, all the features of each of the different embodiments and alternatives shown and/or suggested can be combined. Therefore, the scope of the present invention includes any variant or equivalent that could be considered covered by the broadest scope of the following claims.

What is claimed is:

1. A pharmaceutical compounding device for preparing intravenous medicaments used in chemotherapy comprising:
a compounding area with a robotic compounder, a sash window for closing the compounding area during operation of the device, and a sash window sensor system for detecting the open/closed status of the sash window,
a pre-processor and/or post-processor arranged in said pharmaceutical compounding device and/or in a separated station including a user interface screen and at least one device selected from the group consisting of a weighing device, a code scanner, a label printer and a combination thereof,
a controller with a security circuit for preventing opening of the sash window when the robotic compounder is performing a compounding operation and the sash window is closed,
wherein the controller comprises:
a first control circuit for the compounding area and a second control circuit for the pre-processor and/or post-processor, wherein the control circuits can be used independently from each other performing operations in parallel and the security circuit only acts on the first control circuit.
